(19) United States
(12) Patent Application Publication
(10) Pub. No.: US 2012/0112722 A1
(43) Pub. Date: May 10, 2012

(54) POWER SUPPLY CIRCUIT

(75) Inventor: Sae-Ueng Sakda, Samutprakarn (TH)

(73) Assignee: DELTA ELECTRONICS (THAILAND) PUBLIC CO., LTD., Samutprakarn (TH)

(21) Appl. No.: 13/051,429

(22) Filed: Mar. 18, 2011

(30) Foreign Application Priority Data
Nov. 5, 2010 (TW) 099138247

(51) Int. Cl. G05F 1/10

(52) U.S. Cl. 323/293

(57) ABSTRACT

A power supply circuit includes a first-stage circuit and a second-stage circuit. The first-stage circuit is used for converting an input voltage into a DC voltage. The second-stage circuit includes a main power conversion circuit for converting the DC voltage into a first output voltage, a first standby power conversion circuit for converting the DC voltage into a second output voltage, a feedback circuit for generating a feedback signal, a second standby power conversion circuit and a power distribution circuit. The magnitude of the second output voltage is adjusted by the first standby power conversion circuit according to the feedback signal. The second standby power conversion circuit is used for converting the first output voltage or the second output voltage into a standby voltage. The power distribution circuit is used for selectively delivering the first output voltage or the second output voltage to the second standby power conversion circuit.

### FIELD OF THE INVENTION

The present invention relates to a power supply circuit, and more particularly to a power supply circuit for providing a standby voltage.

### BACKGROUND OF THE INVENTION

With increasing development of the electronic technique, the internal circuitry of the electronic device becomes more complicated. In views of user-friendliness, standby power is continuously provided to some important components of the electronic device at all times. For example, regardless of whether the electronic device is in a power-on state or a power-off state, the standby power is continuously provided to achieve some basic functions (e.g. time indication, power status indication or booting the electronic device). Therefore, the standby power is indispensable to most electronic devices.

FIG. 1 is a schematic circuit block diagram illustrating a power supply circuit for providing standby power according to the prior art. As shown in FIG. 1, the power supply circuit 1 is a two-stage circuit. In particular, the power supply circuit 1 comprises a first-stage circuit 11 and a second-stage circuit 12. The first-stage circuit 11 comprises an electromagnetic interference (EMI) filtering unit 111 and a power factor correction (PFC) unit 112. By the first-stage circuit 11, an input AC voltage V_{AC} is converted into a DC voltage V_{DC}, which is transmitted to the second-stage circuit 12. The second-stage circuit 12 comprises a main power converter 121 and a fly-back power converter 122. During operation of a system circuit (not shown), the DC voltage V_{DC} is converted into an operating voltage Vₒ (e.g. 12V) by the main power converter 121 in order to power the system circuit. Regardless of whether the system circuit is turned on or turned off, the DC voltage V_{DC} is converted into a standby voltage V_{sb} (e.g. 5V) by the fly-back power converter 122. The standby voltage V_{sb} is employed to achieve some basic functions of the system circuit even if the system circuit is in a power-off state. Although the architecture of the power supply circuit of FIG. 1 may provide stable standby power, there are still some drawbacks. For example, since the conversion efficiency of the fly-back power converter 122 is undesired, the power consumption of the overall power supply circuit is too large.

Therefore, there is a need of providing an improved power supply circuit so as to obviate the drawbacks encountered from the prior art.

### SUMMARY OF THE INVENTION

It is an object of the present invention to provide a power supply circuit for increasing the power conversion efficiency and reducing the overall power consumption.

It is further an object of the present invention to provide a power supply circuit for obviating the drawbacks of relatively low conversion efficiency of the fly-back power converter and relatively large power consumption of the power supply circuit encountered from the prior art.

In accordance with an aspect of the present invention, there is provided a power supply circuit. The power supply circuit includes a first-stage circuit and a second-stage circuit. The first-stage circuit is used for converting an input voltage into a DC voltage. The second-stage circuit is connected with the first-stage circuit, and includes a main power conversion circuit, a first standby power conversion circuit, a feedback circuit, a second standby power conversion circuit and a power distribution circuit. The main power conversion circuit is connected with the first-stage circuit for converting the DC voltage into a first output voltage. The first standby power conversion circuit is connected with the first-stage circuit for converting the DC voltage into a second output voltage. The feedback circuit is connected with the main power conversion circuit and the first standby power conversion circuit for receiving the first output voltage and the second output voltage, thereby generating a feedback signal. The magnitude of the second output voltage is adjusted by the first standby power conversion circuit according to the feedback signal. The second standby power conversion circuit is used for converting the first output voltage or the second output voltage into a standby voltage. The power distribution circuit is connected with the main power conversion circuit, the first standby power conversion circuit and the second standby power conversion circuit for selectively delivering the first output voltage or the second output voltage to the second standby power conversion circuit.

In accordance with an aspect of the present invention, there is provided a power supply circuit. The power supply circuit includes a first-stage circuit and a second-stage circuit. The first-stage circuit is used for converting an input voltage into a DC voltage. The second-stage circuit is connected with the first-stage circuit, and includes a main power conversion circuit, a first standby power conversion circuit, a feedback circuit, a second standby power conversion circuit and a power distribution circuit. The main power conversion circuit is connected with the first-stage circuit for converting the DC voltage into a first output voltage. The first standby power conversion circuit is connected with the first-stage circuit for converting the DC voltage into a second output voltage. The feedback circuit is connected with the main power conversion circuit and the first standby power conversion circuit for receiving the first output voltage and the second output voltage, thereby generating a feedback signal to the first standby power conversion circuit. The magnitude of the second output voltage is adjusted by the first standby power conversion circuit according to the feedback signal. The second standby power conversion circuit is used for converting the first output voltage or the second output voltage into a standby voltage. The power distribution circuit is connected with the main power conversion circuit, the first standby power conversion circuit and the second standby power conversion circuit for selectively delivering the first output voltage or the second output voltage to the second standby power conversion circuit. When the main power conversion circuit outputs the first output voltage, the second standby power conversion circuit converts the first output voltage into the standby voltage through the power distribution circuit. When the main power conversion circuit interrupts to output the first output voltage, the second standby power conversion circuit converts the second output voltage into the standby voltage through the power distribution circuit.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating a power supply circuit for providing standby power according to the prior art; and

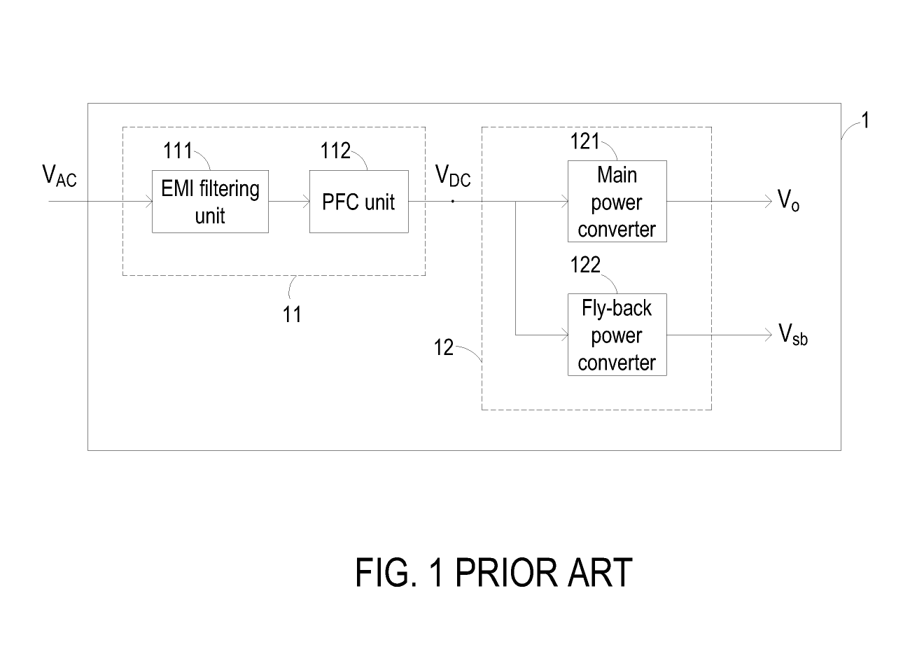

FIG. 2 is a schematic circuit block diagram illustrating a power supply circuit according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

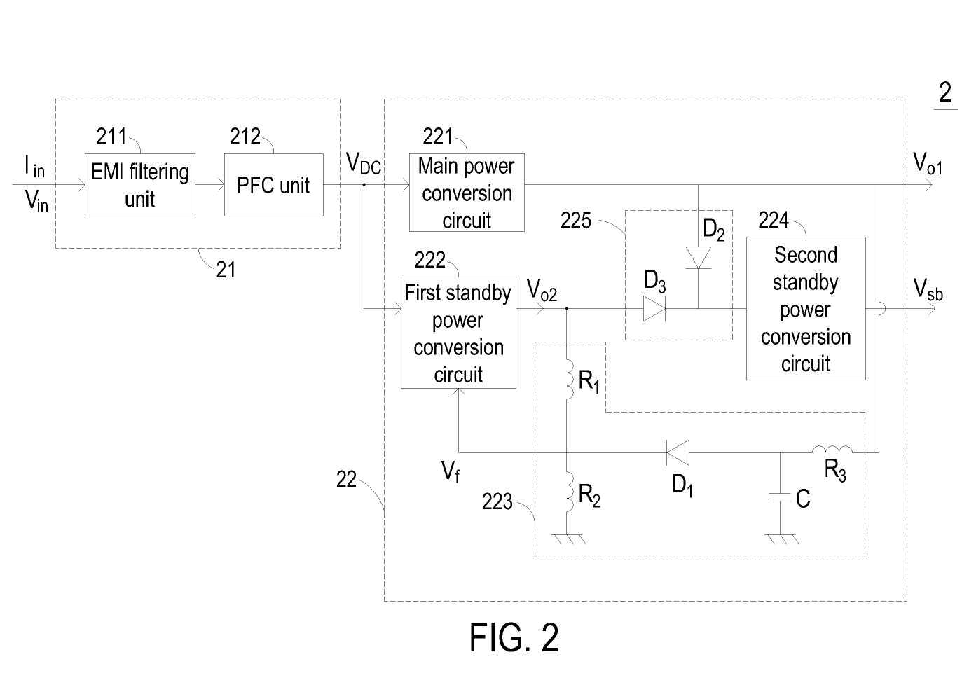

FIG. 2 is a schematic circuit block diagram illustrating a power supply circuit according to an embodiment of the present invention. As shown in FIG. 2, the power supply circuit 2 comprises a first-stage circuit 21 and a second-stage circuit 22. The first-stage circuit 21 is used for converting an input voltage Vᵢₙ into a DC voltage V_{DC}, which is transmitted to the second-stage circuit 22. The first-stage circuit 21 comprises an electromagnetic interference (EMI) filtering unit 211 and a power factor correction (PFC) unit 212. By the PFC unit 212, the distribution of the input current is adjusted to be similar to the sine waveform of the input voltage Vᵢₙ, thereby increasing the power factor. The EMI filtering unit 211 is used for filtering off the high-frequency noise contained in the input voltage Vᵢₙ, thereby smoothing the waveform of the input voltage Vᵢₙ.

Please refer to FIG. 2 again. The second-stage circuit 22 comprises a main power conversion circuit 221, a first standby power conversion circuit 222, a feedback circuit 223, a second standby power conversion circuit 224 and a power distribution circuit 225. The main power conversion circuit 221 is electrically connected with the first-stage circuit 21. During operation of a system circuit (not shown), the DC voltage V_{DC} is converted into a first output voltage Vₒ₁ (e.g. 12V) by the main power conversion circuit 221 in order to power the system circuit. The first standby power conversion circuit 222 is also electrically connected with the first-stage circuit 21. The first standby power conversion circuit 222 is used for converting the DC voltage V_{DC} into a second output voltage Vₒ₂ (e.g. 12V). In addition, a reference voltage V_{ref} is set in the first standby power conversion circuit 222 (not shown).

The feedback circuit 223 is electrically connected with the first standby power conversion circuit 222 and the main power conversion circuit 221. The feedback circuit 223 is used for receiving the first output voltage Vₒ₁ and the second output voltage Vₒ₂, thereby generating a feedback signal V_{f}. According to the feedback signal V_{f} and the reference voltage V_{ref}, the first standby power conversion circuit 222 will adjust the magnitude of the second output voltage Vₒ₂. In this embodiment, the feedback circuit 223 comprises a first resistor R₁, a second resistor R₂ and a first diode D₁. A first end of the first resistor R₁ is connected to an output terminal of the first standby power conversion circuit 222. By a voltage-division circuit formed by the first resistor R₁ and the second resistor R₂, the first output voltage Vₒ₁ and the second output voltage Vₒ₂ are subject to voltage division, thereby generating the feedback signal V_{f}. The first diode D₁ is used for limiting a current-flowing direction. In some embodiments, the feedback circuit 223 further comprises a third resistor R₃ and a capacitor C connected between an output terminal of the main power converter circuit 221 and the first diode D₁ for delaying the timing of modulating the feedback signal V_{f} in response to a change of the first output voltage Vₒ₁.

By the second standby power conversion circuit 224, the first output voltage Vₒ₁ or the second output voltage Vₒ₂ is converted into a standby voltage V_{sb}.

The power distribution circuit 225 is connected with the main power conversion circuit 221, the first standby power conversion circuit 222 and the second standby power conversion circuit 224. In this embodiment, the power distribution circuit 225 comprises a second diode D₂ and a third diode D₃. The anode of the second diode D₂ is connected with the main power conversion circuit 221. The cathode of the second diode D₂ is connected with the cathode of the third diode D₃. The anode of the third diode D₃ is connected with the first standby power conversion circuit 222. By the power distribution circuit 225, the first output voltage Vₒ₁ or the second output voltage Vₒ₂ which has a higher voltage magnitude is delivered to the second standby power conversion circuit 224.

Hereinafter, the operating principle of the power supply circuit 2 will be illustrated with reference to FIG. 2. After the input voltage Vᵢₙ is inputted into the first-stage circuit 21. That is, the input voltage Vᵢₙ is converted into the DC voltage V_{DC} by the EMI filtering unit 211 and the PFC unit 212. The DC voltage V_{DC} is transmitted to the second-stage circuit 22. During operation of the system circuit, which is connected with the power supply circuit 2, by the main power conversion circuit 221, the DC voltage V_{DC} is converted into the first output voltage Vₒ₁ (e.g. 12V) required for powering the system circuit. Regardless of whether the system circuit is in the power-on state or the power-off state, the DC voltage V_{DC} is converted into the second output voltage Vₒ₂ (e.g. 12V) by the first standby power conversion circuit 222. In addition, during operation of the system circuit, the feedback circuit 223 issues the feedback signal V_{f} according to the magnitudes of the first output voltage Vₒ₁ and the second output voltage Vₒ₂. Moreover, the first standby power conversion circuit 222 is operated to adjust the feedback signal V_{f} to be equal to the reference voltage V_{ref} by adjusting the magnitude of the second output voltage Vₒ₂ according to the original feedback signal V_{f} and the reference voltage V_{ref}. In this embodiment, the preset values of the feedback signal V_{f} and the reference voltage V_{ref} are both 2.5V. As a consequence, when the system circuit is operated and the feedback signal V_{f} issued from the feedback circuit 223 is higher than 2.5V due to the first output voltage Vₒ₁ with relatively higher voltage level, for maintaining the reference voltage V_{ref} to be equal to the feedback signal V_{f}, the controlling circuit (not shown) within the first standby power conversion circuit 222 may adjust the magnitude of the second output voltage Vₒ₂. That is, the magnitude of the second output voltage Vₒ₂ is adjusted to be reduced from 12V to 9V for example. In this situation, the magnitude of the first output voltage Vₒ₁ is higher than the magnitude of the second output voltage Vₒ₂. At the moment, the second diode D₂ of the power distribution circuit 225 is conducted, so that the first output voltage Vₒ₁ is allowed to be delivered to the second standby power conversion circuit 224. The first output voltage Vₒ₁ is converted into the standby voltage V_{sb} by the second standby power conversion circuit 224. Moreover, the operating efficiency of the main power conversion circuit 221 is higher than that of the first standby power conversion circuit 222. That is, since the main power conversion circuit 221 is the power source to offer the standby voltage V_{sb} during the operation of the system circuit, the operating performance of the power supply circuit 2 is enhanced. Whereas, the second output voltage Vₒ₂ results in a no-load close loop.

In a case that the system circuit is in the power-off state, the DC voltage V_{DC} is no longer converted into the first output voltage Vₒ₁ by the main power conversion circuit 221 or the main power conversion circuit 221 interrupts to output first output voltage Vₒ₁. Meanwhile, the magnitude of the first output voltage Vₒ₁ is zero. In addition, since the feedback signal V_{f} issued from the feedback circuit 223 will be lower than 2.5V due to the second output voltage Vₒ₂ (e.g. 9V) only, for maintaining the reference voltage V_{ref} to be equal to the feedback signal V_{f}, the controlling circuit (not shown) within the first standby power conversion circuit 222 may adjust the magnitude of the second output voltage Vₒ₂. That is, the magnitude of the second output voltage Vₒ₂ is adjusted to be increased from 9V to 12V for example. In this situation, the magnitude of the second output voltage Vₒ₂ is higher than the magnitude of the first output voltage Vₒ₁. At the moment, the third diode D₃ of the power distribution circuit 225 is conducted, so that the second output voltage Vₒ₂ is allowed to be delivered to the second standby power conversion circuit 224. The second output voltage Vₒ₂ is converted into the standby voltage V_{sb} by the second standby power conversion circuit 224.

From the above description, in the power supply circuit of the present invention, the first output voltage outputted from the main power conversion circuit and the second output voltage outputted from the first standby power conversion circuit are received by the feedback circuit, and the feedback circuit issues a feedback signal according to the first output voltage and the second output voltage. According to the feedback signal, the magnitude of the second output voltage is adjusted by the first standby power conversion circuit. The power distribution circuit is used for selectively delivering the first output voltage or the second output voltage to the second standby power conversion circuit. Since the main power conversion circuit with the higher operating efficiency is used as the source to offer the standby voltage during the operation of the system circuit, the operating performance of the power supply circuit is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply circuit, comprising:
a first-stage circuit for converting an input voltage into a DC voltage; and
a second-stage circuit connected with said first-stage circuit, and comprising:
a main power conversion circuit connected with said first-stage circuit for converting said DC voltage into a first output voltage;
a first standby power conversion circuit connected with said first-stage circuit for converting said DC voltage into a second output voltage;
a feedback circuit connected with said main power conversion circuit and said first standby power conversion circuit for receiving said first output voltage and said second output voltage, thereby generating a feedback signal, wherein the magnitude of said second output voltage is adjusted by said first standby power conversion circuit according to said feedback signal;
a second standby power conversion circuit for converting said first output voltage or said second output voltage into a standby voltage; and
a power distribution circuit connected with said main power conversion circuit, said first standby power conversion circuit and said second standby power conversion circuit for selectively delivering said first output voltage or said second output voltage to said second standby power conversion circuit.

2. The power supply circuit according to claim 1 wherein said first-stage circuit comprises:
a power factor correction unit for adjusting the distribution of an input current to be similar to a sine waveform of said input voltage; and
an electromagnetic interference filtering unit for filtering off high-frequency noise contained in said input voltage, thereby smoothing said waveform of said input voltage.

3. The power supply circuit according to claim 1 wherein said first standby power conversion circuit has a reference voltage, wherein the magnitude of said second output voltage is adjusted by said first standby power conversion circuit according to said feedback signal and said reference voltage.

4. The power supply circuit according to claim 1 wherein said feedback circuit comprises a first resistor and a second resistor, wherein by said first resistor and said second resistor, said first output voltage and the second output voltage are subject to voltage division, thereby generating said feedback signal.

5. The power supply circuit according to claim 4 wherein said feedback circuit further comprises a third resistor and a capacitor for delaying the timing of modulating said feedback signal in response to a change of said first output voltage.

6. The power supply circuit according to claim 5 wherein said feedback circuit further comprises a first diode for limiting a current-flowing direction.

7. A power supply circuit, comprising:
a first-stage circuit for converting an input voltage into a DC voltage; and
a second-stage circuit connected with said first-stage circuit, and comprising:
a main power conversion circuit connected with said first-stage circuit for converting said DC voltage into a first output voltage;
a first standby power conversion circuit connected with said first-stage circuit for converting said DC voltage into a second output voltage;
a feedback circuit connected with said main power conversion circuit and said first standby power conversion circuit for receiving said first output voltage and said second output voltage, thereby generating a feedback signal to said first standby power conversion circuit, wherein the magnitude of said second output voltage is adjusted by said first standby power conversion circuit according to said feedback signal;
a second standby power conversion circuit for converting said first output voltage or said second output voltage into a standby voltage; and
a power distribution circuit connected with said main power conversion circuit, said first standby power conversion circuit and said second standby power conversion circuit for selectively delivering said first output voltage or said second output voltage to said second standby power conversion circuit,
wherein when said main power conversion circuit outputs said first output voltage, said second standby power conversion circuit converts said first output voltage into said standby voltage through said power distribution circuit; and when said main power conversion circuit interrupts to output said first output voltage, said second standby power conversion circuit converts said second output voltage into said standby voltage through said power distribution circuit.

8. The power supply circuit according to claim 7 wherein said first standby power conversion circuit has a reference voltage, wherein the magnitude of said second output voltage is adjusted by said first standby power conversion circuit according to said feedback signal and said reference voltage.

9. The power supply circuit according to claim 7 wherein said feedback circuit comprises a first resistor and a second resistor, wherein by said first resistor and said second resistor, said first output voltage and the second output voltage are subject to voltage division, thereby generating said feedback signal.

10. The power supply circuit according to claim 9 wherein said feedback circuit further comprises:
a third resistor and a capacitor for delaying the timing of modulating said feedback signal in response to a change of said first output voltage; and
a first diode for limiting a current-flowing direction.
